(19) United States
(12) Patent Application Publication
(10) Pub. No.: US 2022/0391853 A1
(43) Pub. Date: Dec. 8, 2022

(54) Service Bay Timer System and Method

(71) Applicant: Service Write, Inc., Greenville Road, NC (US)

(72) Inventors: Peter Andrew Seymour, Greenville, NC (US); Marcus Aman, Winterville, NC (US); Matthew Blackmon, Winston-Salem, NC (US)

(21) Appl. No.: 17/498,038

(22) Filed: Oct. 11, 2021

Related U.S. Application Data
(60) Provisional application No. 63/208,237, filed on Jun. 8, 2021.

(51) Int. Cl. G06Q 10/00; G06Q 10/06

(52) U.S. Cl. CPC G06Q 10/20; G06Q 10/063114

(57) ABSTRACT

The Service Bay Timer or SBT system and corresponding methodology are designed to generally increase job performance of vehicle service technicians while they work on vehicles in service centers. The SBT system identifies bottlenecks in particular services and alerts service technicians and staff of potential issues. The Service Bay Timer system uses complex algorithms to recognize issues and trends and report those issues and trends. By increasing awareness of service bay usage, the amount of time expenditure for a given vehicle while in for a particular service, and the time a service bay is not being used, policies and procedures can be enacted to correct and or enhance each service. The system creates a logical view of the vehicles in the service center tracking vehicle whereabouts and providing status updates during the entire process.

### PRIOR HISTORY

This applications claims the benefit of pending U.S. Provisional Patent Application No. 63/208,237 filed in the United States Patent and Trademark Office (USPTO) on 8 Jun. 2021, the specifications and drawings of which are hereby incorporated by reference thereto.

### FIELD OF THE INVENTION

The present invention generally relates to a system and method for tracking and guiding vehicular service bay activities. More particularly the present invention relates to a system comprising a series of devices that are together used to track and guide a service technician at a vehicular service bay station while the service technician performs certain technical tasks. The system and method according to the present invention centers on time management and logistics for service centers.

### BRIEF DESCRIPTION OF THE PRIOR ART

Automotive service technicians perform services on automobiles that require a specific amount of time to perform. Specific tasks to be performed collectively constitute a repair order or list of repairs for a specific vehicle. The service center will typically invoice the customer for the specific tasks based on the amount of time each specific task takes to perform. These are generally known as labor costs. It is often very difficult to manage the time it takes for different technicians with different levels of expertise and motivation to accomplish these services in the recommended amount of time. Even more difficult is the tracking of the time required for each component and identifying where bottlenecks occur within the service protocol that may prevent technicians from completing the services faster and with more efficiency. The process is further hampered by the limited ability of technicians to properly or efficiently learn the status of parts, customer approvals, customer wait status and other important information that often dictates or requires that a technician to pause their work and seek out this important information.

There are many service sites that comprise a service bay station, examples of which include technician bays, alignment racks, tire stations, car wash bays, and more. The prior art does not provide means for alerting technicians when a shared service bay station becomes available thereby creating scheduling conflicts that result in vehicles being queued for station availability and wasting time. Furthermore, service advisors, who are responsible for engaging the customer and the technician to facilitate the completion and communication of a repair order, must often rely upon feedback from technicians for updates about repair orders. The service advisor must then communicate with the customer and provide recommendations about the original complaint and offer additional recommendations for achieving a more robust solution for a given vehicle requiring service. It is noted that a service advisor is frequently required to walk to the shop floor to converse with technicians about the status of a vehicle being serviced thereby further compounding the inefficiencies.

The prior art perceives a need for a system that eliminates the inefficiencies associated with state-of-the-art service bay station practices by continually monitoring service time a service technician is spending at the service bay station on a repair order, analyzing data as collected by the system through a user interface in combination with time expenditures so as to provide direction and governance to the service technician and he or she moves through a repair order.

Using off the shelf technologies combined in a unique way, the service bay timer system according to the present invention collects data from technicians, bays, satellite devices on specific equipment and more. Using the data gained from the system, the non-transitory, computer-implementable medium or software application, central to the practice of the present invention, makes informed decisions employing artificial intelligence to find patterns and logistically arrange the order of services based on patterns and data received by the system as summarized in more detail hereinafter.

### SUMMARY OF THE INVENTION

When a service technician performs a service task such as an oil change on a vehicle, there is a preferred service protocol or series of service steps that must be taken to assure the oil change service is completed correctly from start to finish. Each step takes a certain amount of time which can vary from car model to car model. The Service Bay Timer (SBT) system according to the present invention provides a solution by presenting the entire repair order service protocol or series steps in a concise list displayed on a user interface visual display exemplified by an IP67 ruggedized touch screen monitor.

For each service step of the service request, the SBT system according to the present invention provides detailed instructions as listed on the visual display, ordered using artificial intelligence, in the fastest sequence based on previously collected vehicle-specific data. The time expenditure spent on each step by the service technician is then collected and stored by the SBT system. Using integration with current Dealer Management Systems to obtain specific data points and electronic sensors from the SBT electronics, the SBT system monitors a vehicle being serviced during each step of the process.

When a vehicle first enters the service center, a repair order creation time is recorded and used as a starting point for any given repair order. When a vehicle arrives at a service bay station, a timestamp is recorded for the start of the service by an electronic sensor. This information is relayed to an advisor or other employees as well as the customer if so desired by the service center. As each item of the repair order is completed, the technician touches the screen, recording the time of the service which is recorded and used to determine many logistical calculations. When the vehicle leaves the service bay station, an electronic sensor records the time stamp. The entire process is broken into steps and recorded so that times can be stored and used in real time calculations and provided as real time data to interested parties. The data can also be used to track the performance of individual technicians.

The time stamp mentioned hereinabove could represent the end of the repair order or it could be that the vehicle is just being moved to say an alignment rack, but the repair order is still active. The vehicle could very well come back to the original service bay station at which station the repair order would continue. Alternatively, the vehicle could be delivered to another service technician for another part of the service repair order. In this regard, the system is able to determine which service technician would be best for which item within the repair order and also is able to determine availability of alternative service technicians. The system provides a robust logistical system which can be used to save time by routing the correct job to the correct technician.

A proprietary software application, implemented by a computer-processor device of the SBT system, accompanies the computer-processor device or hardware and is operable to display a running time for each repair order and individual service steps the repair order comprises. The software application or non-transitory, computer-implementable medium is operable to display the time each step should take according to the current standardized labor rates or custom values. By providing detailed time information for each step as displayed upon the user interface to the service technician, the SBT system according to the present invention assures that all steps are taken and completed in a timely manner by monitoring each step during the process as updated by the technician. The software of the system calculates which steps take the most time and which technicians are best or most efficient at which steps. This is valuable information for service center owners/managers and can be used to direct or route repair orders, or portions of repair orders, to certain technicians based on strength and/or efficiency of service for a given repair order or portion thereof.

The visual display of the user interface prompts the service technician to touch the screen to move the process forward to the next item in the repair order once a repair step has been completed. Each time a new item is selected, the time expenditure on the previously completed step is recorded. This is an important data point that is recorded and associated with the profile of the service technician. Using data collected in this manner the SBT system is operable to deduce very important information about performance metrics for various service technicians. These metrics include but are not limited to time for each service, time to complete a multipoint inspection, and the amount and number of upsells offered and accepted.

The key internal software application of the SBT system records the amount of time individual technicians take to perform repair order tasks. These times may be preferably used to rank the technicians. This ranking practice can be used to reward and/or gamify the services. This gamification can be used to compare technicians for any given service center, dealership, dealership group, and further provide nationwide or worldwide rankings depending on data recorded.

The SBT system according to the present invention comprises at least one, but preferably a series of signaling devices exemplified by ultrasonic sensors, RFID/NFC sensors, infrared lasers, pressure sensitive devices, cameras or other apparatus capable of sending signals that detect when a vehicle has entered the service bay station. As the vehicle is positioned into the service bay station, its presence in the service bay station is detected by the series of sensors/signaling devices indicating via electronic communication with the SBT system that a vehicle has entered the service bay station.

The vehicle entering the service bay station triggers the sensors/signaling devices to monitor vehicular presence in the service bay station until the vehicle exits or leaves the service bay station. The preferable inclusion of at least two or more sensors/signaling devices, and as particularly positioned relative the service bay station, prevents accidental signaling by the user or service technician or other objects within the space defined by the service bay station as might otherwise occur when a single sensor/signaling device is deployed.

When a signal is sent to the SBT system indicating a vehicle has exited or left the service bay station, an “in service” timer stops and remains displayed on an optional indicator monitor or Light Emitting Diode (LED) display. The displayed “in service” time for the previous car will remain on the display until it is reset by a successive vehicle entering the service bay station and the sensor/signaling device triggers a new time-keeping log for the next successive vehicle in the same service bay station.

When an automobile or vehicle leaves or exits a service bay station it then becomes “out of service”, and a timer will start that tracks the time between the “out of service” condition of the service bay station and the “in service” condition of the service bay station when a vehicle re-enters the service bay station (it being noted that the re-entry vehicle may be a successive vehicle or a returning vehicle). The tracking of time for the “out of service” condition informs the owner/management when the service bay station is not in use. This time can also be displayed on the monitor, Light Emitting Diode (LED) display or some other device that can display the time. This time will also be stored by the software application of the SBT system and can be utilized to find data points that can be displayed on a dashboard available to service center advisors, technicians and other employees.

State-of-the-art service bay systems do not require that a monitor be placed at key stations to record when a vehicle is being serviced in those stations. Preferably using RFID/NFC readers and electronic sensors the SBT system according to the present invention is notified when a vehicle has entered one of these monitored stations. Reading an RFID/NFC chip on a sticker or some other medium, the remote Service Bay Timer or SBT system according to the present invention records the and times the visit to these stations. Each serviced vehicle is preferably provided with an RFID/NFC sticker that attaches to the back of a key tag, for example. When a repair order is created a key tag is created. At the time of repair order creation, the sticker can be attached and then scanned by a remote Service Bay Timer system to associate the RFID/NFC with the repair order which can be used to track the vehicle throughout the service center during the visit.

This data is used to manage the scheduling of vehicular service among various service bay stations as well as the vehicular flow within a service center. All times are stored and can be accessed for use in later calculations or processing protocols. Gathered data may also be sent to customers for real time information on the status of repair orders and may also be sent to advisors to provide a real time snap shots of the status of all service bay stations outfitted with the Service Bay Timer system according to the present invention.

Further, all times may be saved and used for comparison purposes, including, but not limited to the following: (a) comparing actual service times to industry standard times for different services; (b) comparing service times for different service technicians to provide a ranking; (c) compare different steps of each repair process to determine if any steps were missed or incomplete; (d) comparing cumulative times to learn how often a service bay station is in use; (e) comparing the order of services rendered to provide a logistical strategy for more properly ordering the items in a repair order to save the most time; and (f) comparing times on a daily/weekly/monthly/yearly basis to discover trends.

The computer processor device processes or computes the data as collected from the service bay sensors, is able to communicate with external computing systems preferably via wireless communications using a wireless networks or Bluetooth capable devices. Alternative means for collecting and communicating date are contemplated, however, and may include USB cord, SSD cards, or software solutions to deliver data. The computer-processor device is programmed with a mutable set of the most common services and is outfitted with the non-transitory, computer-implementable medium or software application central to the practice of the SBT system. The services can thus be programmed into the processor or the processor can communicate with an external system to retrieve additional services, steps, and times or updated steps and times for existing services that are standard and or required for each type of service. These times and steps are sent to the visual display of the user interface to inform the service technician.

The data is compiled and sent to a customizable visual display that makes up a real time view of the current status of all vehicles monitored by the Service Bay Timer or SBT system according to the present invention. This dashboard displayed upon the visual display of the user interface is capable of showing multiple views into the data that represent individual vehicles or service technicians. Advisors or other employees can either remotely or on-site monitor the status of the vehicles and the services being performed throughout the service center. Further, the dashboard may be configured for a dealer group comprising multiple individual dealerships allowing the owner or managers of all dealerships to obtain a real time view across all service stations or centers. In other words, the present invention provides a group interface whereby service stations or centers of a group can be organized into that group view providing a different specialized view across dealerships within that group.

Each vehicle is represented as a separate piece of data that includes, but is not limited to: (a) information regarding the timing of the repair order; (b) the status of parts and parts availability; (c) the status of the customer (e.g. waiting in lobby or remotely); (d) pickup or delivery of the vehicle; (e) whether the customer been contacted; (f) whether media been sent to the customer, (e.g. photos or video); and (g) whether the vehicular repair is currently on time.

### BRIEF DESCRIPTIONS OF THE DRAWINGS

Other features and objectives of the invention will become more evident from a consideration of the following brief descriptions of patent drawings.

FIG. 1 is a first frontal elevational view of a vehicle received within a generic service bay station in a first position of service by way of the service bay timer system according to the present invention.

FIG. 1A is a second frontal elevational view of the vehicle received within the generic service bay station otherwise depicted in FIG. 1 depicting the service bay station in communication with a remote cloud-based solution and data storage in a database solution of the service bay timer system according to the present invention.

FIG. 2 is a first frontal elevational view of a vehicle received within a generic service bay station in a second position of service by way of the service bay timer system according to the present invention.

FIG. 2A is a second frontal elevational view of the vehicle received within the generic service bay station otherwise depicted in FIG. 1 depicting the service bay station in communication with a remote cloud-based solution and data storage in a database solution of the service bay timer system according to the present invention.

FIG. 2B is a diagrammatic depiction of a series of components in electrical communication with one another including a computer-processor device, a remote cloud computing network and a remote storage database.

FIG. 3 is a first sequential side elevational view of a service bay station with a vehicle being positioned for entry into the service bay station.

FIG. 3A is a second sequential side elevational view of the service bay station with vehicle being re-positioned into the service bay station for triggering a series of sensors that a vehicle is present in the service bay station.

FIG. 3B is a third sequential side elevational view of the service bay station with vehicle being positioned with the service bay station in the first position of service and thereby triggering a timer via the series of sensors sensing that a vehicle is present in the service bay station.

FIG. 3C is a fourth sequential side elevational view of the service bay station with vehicle being re-positioned within the service bay station in the second position of service and being timed by the timer via the series of sensors sensing that a vehicle is present in the service bay station.

FIG. 4 is a frontal view of a visual display of a user interface of the service bay timer system according to the present invention.

FIG. 5 is a screenshot showing a remote operator viewpoint of a plurality of service bay timers in an activated state within a service center or shop.

FIG. 6 is a visual depiction of a single first point in a multi-point inspection process for prompting the service technician as he navigates through the multi-point inspection process.

FIG. 7 is a visual depiction of a series of multi-point inspection results delivery choices by a service technician, service advisor or other employee with permissions.

FIG. 8 is a visual depiction of an awards-based system built into the service bay timer system according to the present invention.

FIG. 9 is a first flowchart type diagram showing the process of a service technician initiating the service bay timer system according to the present invention.

FIG. 10 is a second flowchart type diagram showing the process of a repair order search process of the service bay timer system according to the present invention.

FIG. 11 is a third flowchart type diagram showing the process of a triage process of the service bay timer system according to the present invention depicting prioritization of repair orders.

### DETAILED DESCRIPTION OF THE PREFERRED EMBODIMENTS

Embodiments of systems, components, and methods associated therewith will now be described with reference to the accompanying figures. Although several embodiments, examples, and illustrations are disclosed below, it will be understood by those of ordinary skill in the art that the embodiments described herein extend beyond the specifically disclosed configurations, examples, and illustrations, and can include other users of the disclosure and obvious modifications and equivalents thereof. The terminology used in the descriptions presented herein is not intended to be interpreted in any limited or restrictive manner simply because it is being used in conjunction with a detailed description of certain specific embodiments of the disclosure. In addition, embodiments of the disclosure can comprise several novel features and no single feature is solely responsible for its desirable attributes or is essential to practicing any one of the several embodiments herein described.

Certain terminology may be used in the following description for the purpose of reference only, and thus are not intended to be limiting. For example, terms such as “above” and “below” refer to directions in the drawings to which reference is made. Terms such as “front,” “back,” “left,” “right,” “rear,” “top,” “bottom” and “side” describe the orientation and/or location of portions of the components or elements within a consistent but arbitrary frame of reference which is made clear by reference to the text and the associated drawings describing the components or elements under discussion. Moreover, terms such as “first,” “second,” “third,” and so on may be used to describe separate components. Such terminology may include the words specially mentioned above, derivatives thereof, and words of similar import.

Referring now to the drawings with more specificity, the following specifications generally describe a service bay timer system for gathering data from a service bay station, processing data gathered from the service bay station, and providing feedback to a service bay technician at the service bay station for improving use of service time by the service technician at the service bay station. The Service Bay Timer or SBT system according to the present invention preferably comprises, in combination, a service bay station as at 10, at least one signaling device as at 11, a computer-processor device as at 12, at least one timer device 13, a user interface as at 14, and an internal non-transitory, computer-implementable medium or software application implementable by at least the computer-processor device 12 and peripheral supportive computing devices in communication therewith including cloud based solutions as exemplified by Amazon Web Services (AWS) Cloud based solution.

The service bay station 10 is configured to receive a vehicle 15 for service and preferably comprises at least one device-support structure as at vertically upright support posts 16 or overhead support beams 17. Notably, not all service bay stations 10 comprise such features as vertically upright support posts 16 or horizontal overhead support beams 17 of the type illustrated. In this regard, it is contemplated that the at least one, but preferably two or more signaling devices 11, are preferably supported by at least one device-support structure of a service bay station 10 so as to properly sense the arrival and presence of a vehicle 15 for the duration of the service visit.

The at least one device-support structure of a service bay station 10 is nevertheless preferably exemplified by either vertically upright support posts 16 or horizontal overhead support beams 17. The key structural feature for the service bay station 10 is to provide some signal device or sensor device support structure in adjacency to the work station for the vehicle 15 so that the signaling devices together monitor the presence of the vehicle 15 within the work station for driving the timer devices to mark time of service. The user interface is also preferably supported by the at least one device-support structure of the service bay station 10 so that the user or service technician has ready access to input thereinto and receive output therefrom while servicing the vehicle 15.

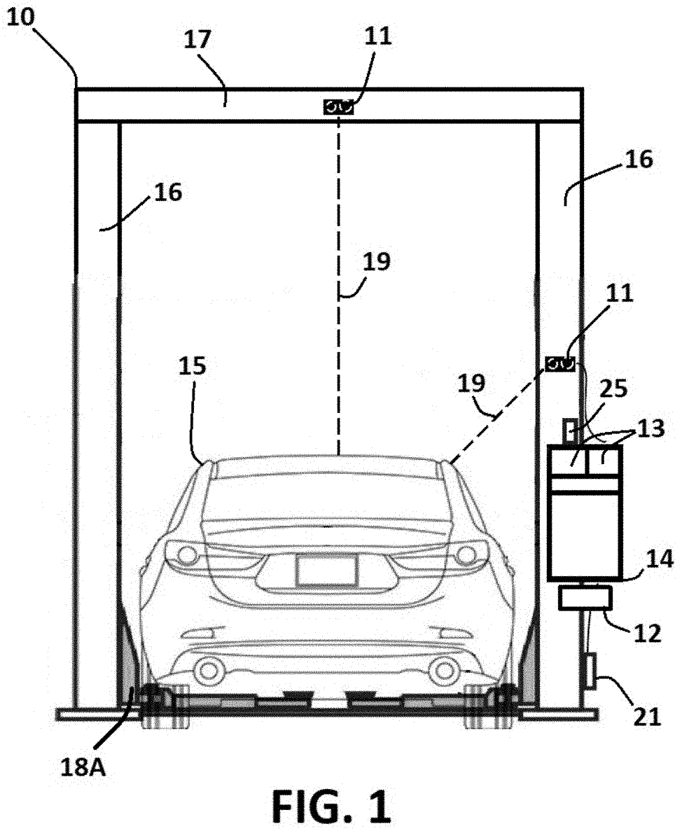

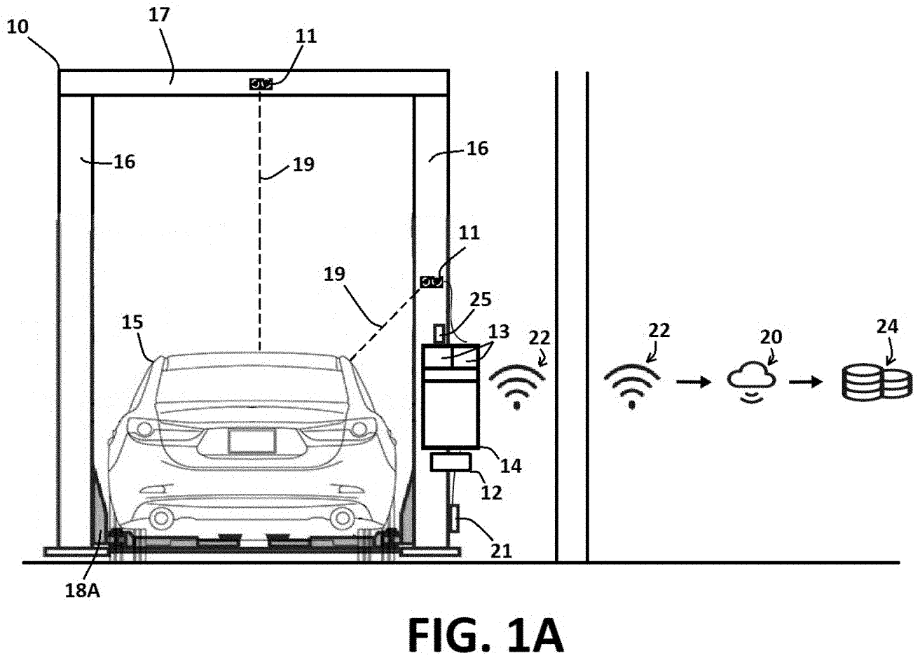

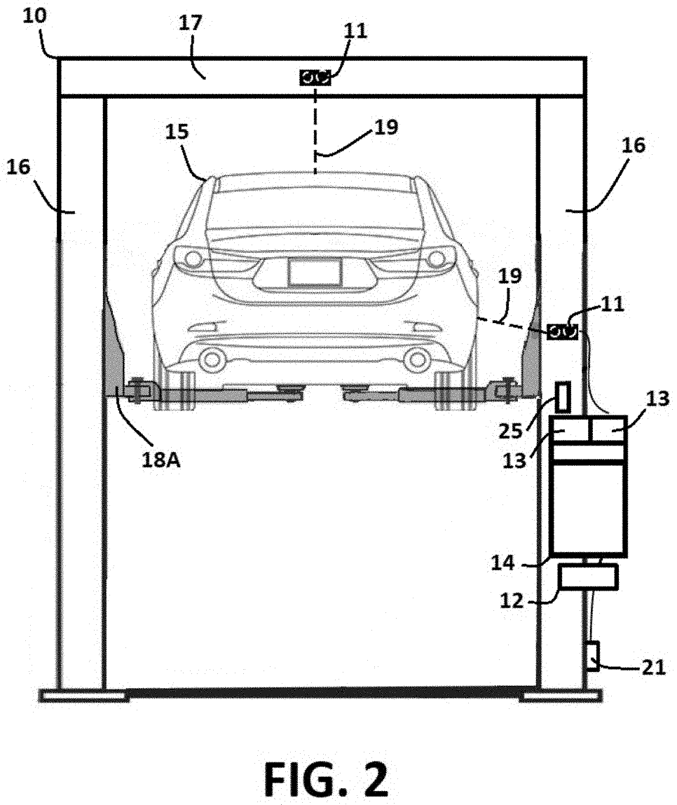

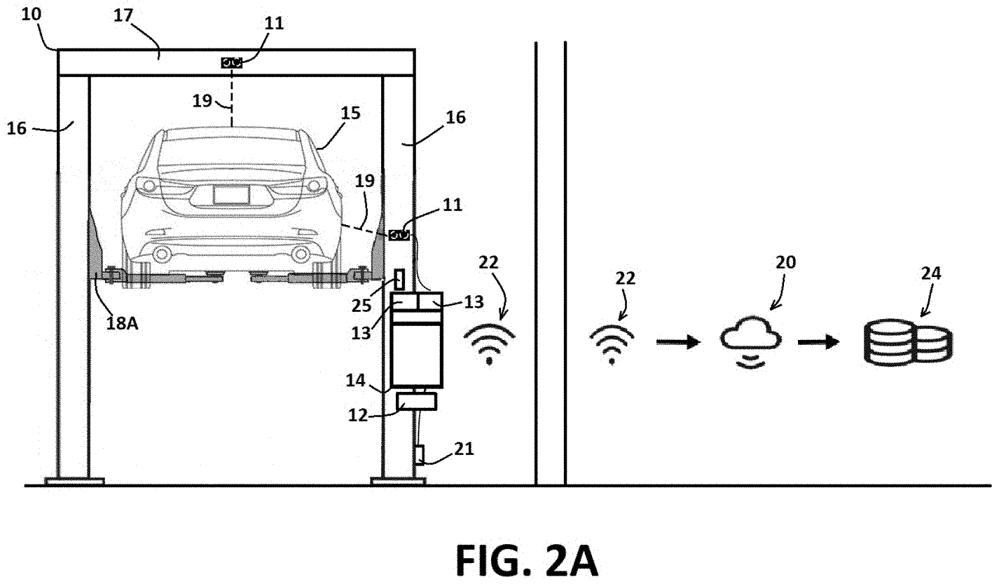

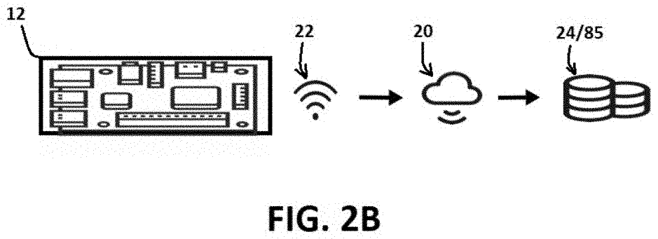

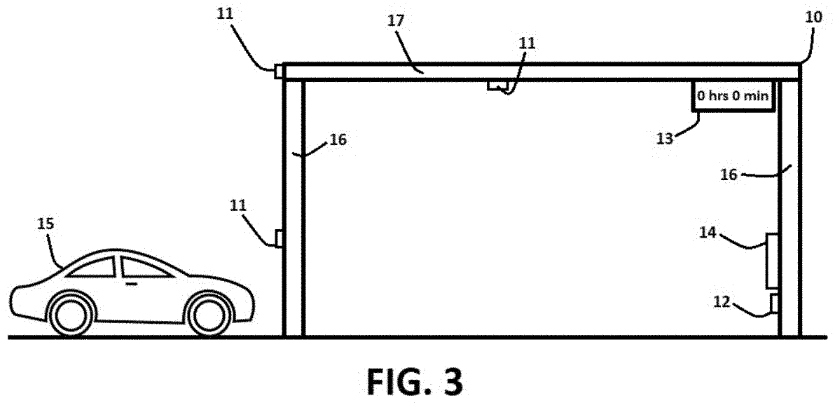

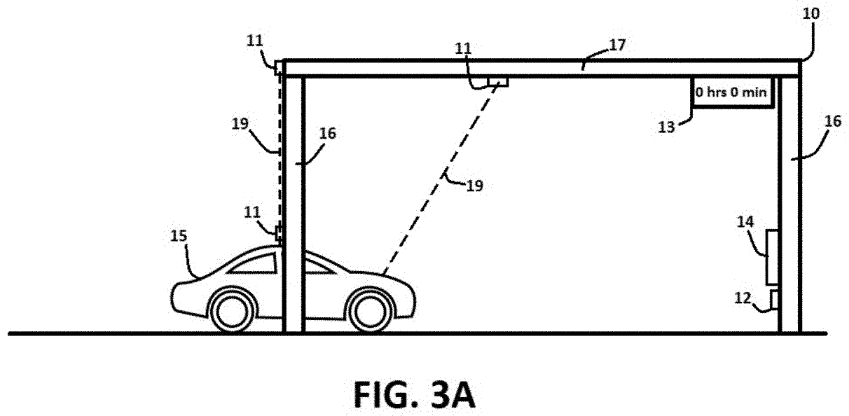

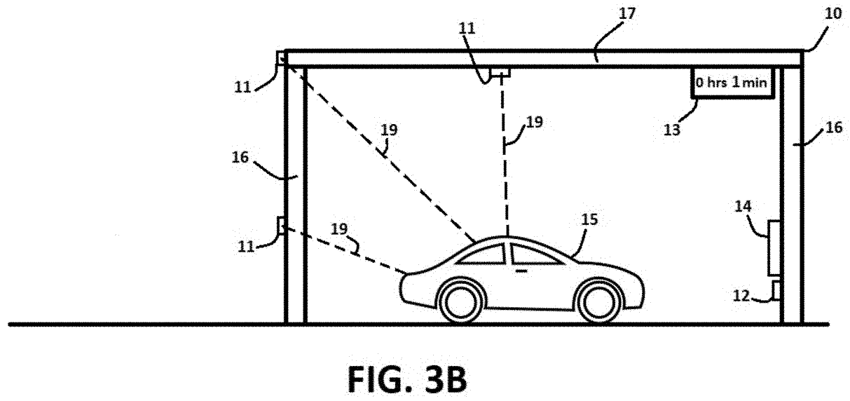

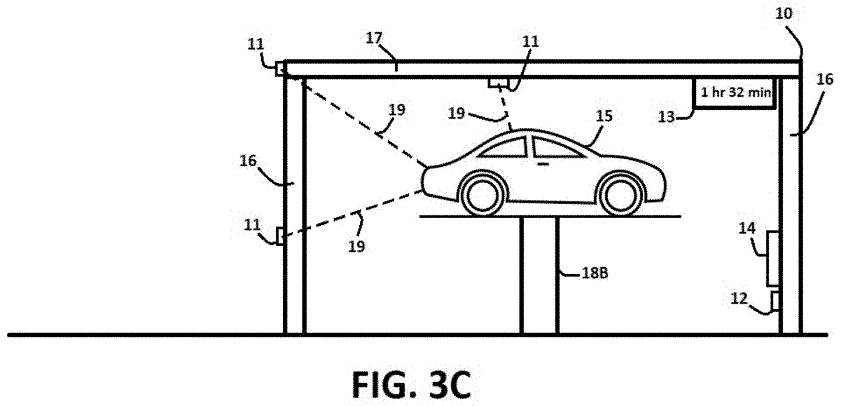

The illustrations submitted in support of these specifications demonstrate the systemic components and/or sub-systems required to generate and record data throughout the process of servicing a vehicle 15. The service bay station 10 may further comprise a vehicle lift mechanism as alternatively depicted at 18A and 18B. The vehicle lift mechanisms 18A/18B operate to raise the vehicle 15 making it easier to access for service. The signal sensors 11 are positioned to send data when a vehicle 15 is driven into or positioned with the service bay station 10 and continue to report a signal while the vehicle 15 is in any position on the lift mechanisms 18A/18B from fully raised as generally depicted in FIGS. 2, 2A, and 3C to completely lowered as generally depicted in FIGS. 1, 1A, and 3B.

FIG. 1 provides a view of the ruggedized touch screen display user interface as at 14 and sensors 11 are preferably attached to the frame (comprising posts 16 and beam 17) of the service bay lift mechanism 18A or other fixed positions within or at the service bay station 10. FIGS. 3-3C depict a series of three sensors/signaling devices 11 positioned at various locations obliquely angled relative to one another and the finally positioned vehicle 15 for enhancing the measure of time for the service visit at the service bay station 10.

FIGS. 1 and 2 particularly depict a vehicle 15 in the service bay station 10 with signaling/sensor devices 11 (exemplified by ultrasonic sensors) detecting the vehicle 15 presence via ultrasonic sound waves 19. In this case, sound waves 19 determine the distance of any object in the service bay station 10. The ultrasonic sensor type signaling/sensing device sends out waves as at 19 to detect objects. This basic function can also be performed using cameras, lasers, or other distance sensing electronic devices. The user of two or more signaling devices 11 helps ensure proper vehicular presence readings.

The devices 11 feed a signal back to the remote computer-processor device 12, which uses a threshold setting to signal if a vehicle 15 has arrived or departed a service bay station 10. This signal is used to determine the total time a vehicle 15 is in the service bay station 10 for a repair order and sends that data to the remote cloud computing network as at 20 to be processed by algorithms on the remote servers within the cloud computing network 20. When the SBT system is triggered by signal/sensor devices 11 when detecting the presence of a vehicle 15, a signal is sent to the computer-processor device 12 notifying the non-transitory, computer-implementable medium or software application to start one or more timer mechanisms 13. The computer-processor device 12 sends information to the user interface 14 or other device to display a set of timers 13, recommendations, and information about the service technician and the customer. During the entire process of a vehicle 15 being serviced, data is continuously recorded and sent to the computer-processor device 12 via the signaling devices 11 and data input at the user interface 14.

Sensors 11 send signals back to the SBT system that determine if a vehicle 15 has entered the service bay station 10. In the illustrations set forth in FIGS. 1 and 1A, a sensor 11 is mounted on the side or vertically upright support post 16 of the lift mechanism 18A. These sensors 11 can also be mounted above the lift mechanism if there is a horizontal support as at beam 17 going between the vertical supports 16. Noting that this structural configuration may not always present, the sensors 11 must generally be placed in any supported position that provides a view into the service bay station 10.

The SBT system further requires a power source as exemplified by a 120 v AC power receptacle as at 21, and a Wi-Fi, LTE, or Bluetooth signal as at 22 to communicate with the computer-processor device 12. The SBT system may further preferably comprise an RFID/NFC sensor as at 25 mounted on top of the user interface 14 that energizes RFID/NFC stickers, chips, tokens, phones and other devices that can be used to identify a service technician or a vehicle 15 entering the service bay station 10. The RFID/NFC sensor 25 may be said to exemplify certain means for token-identifying a repair protocol for select vehicles 15 entering the service bay station 10. The select vehicle(s) 15 entering the service bay station 10 may each be preferably outfitted with an information-bearing token (e.g. RFID/NFC stickers, chips, tokens). The means for token-identifying a repair protocol reads the information-bearing tokens for triggering a select repair protocol for each select vehicle 15 entering the service bay station 10, which repair protocol is output upon the visual display 23 of the user interface 14.

It will thus be understood that the computer-processor device 12 is in communication with the at least one signaling device 11 for receiving signals therefrom and that at least one timer device 13 is in communication with the computer-processor device 12. Signals from the signaling devices 11 initiating the series of timer devices 13 via or by way of the computer-processor device 12 and the software application implemented thereby. Time, as measured by the timer mechanisms, may be displayed upon the user interface 14 or other displays associated with the service bay station 10 as generally referenced at 13. The user interface 14 is also in communication with the computer-processor device 12 and enables a user such as a service technician 100 enabling the user or service technician 100 to input data for processing by the computer-processor device 12 and outputs data as variously processed to the user or service technician as at 100 for guiding and governing service technician behavior at the service bay station 10.

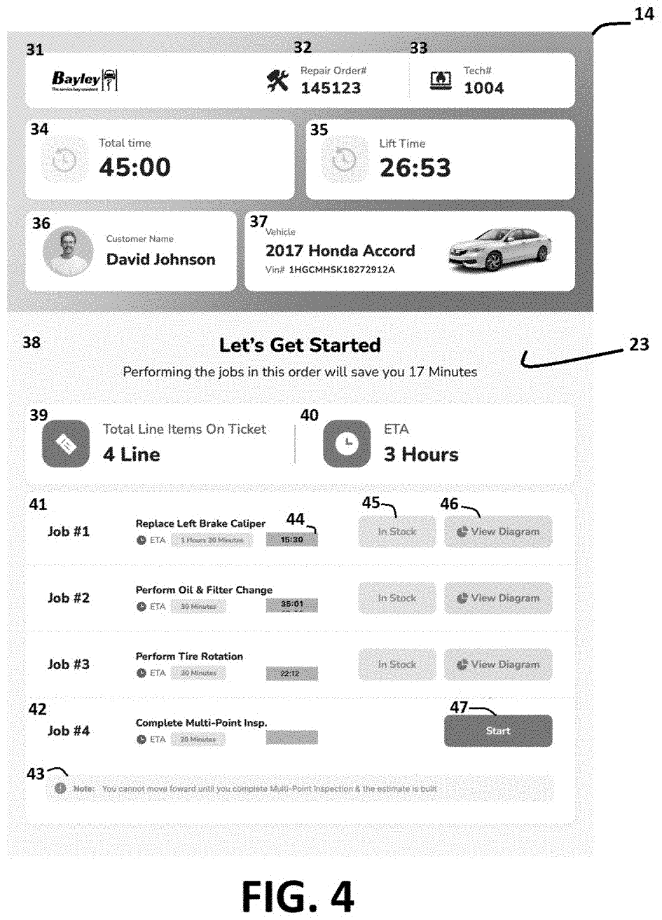

Referencing FIG. 4, the reader will there consider a frontal view of the touch screen visual display 23 of the user interface 14. This user interface 14 is preferably exemplified by an IP67 ruggedized touch screen display. The displayed output, may however, be displayed on other display devices including but not limited to a mobile communications device such as a mobile phone and or a tablet computer. The main device is the touchscreen visual display 23, and the touchscreen visual display 23 is mounted on a service bay station device support structure (as at column or post 16) and always available to a specific service bay station 10. The visual display 23 of the user interface 14 is preferably powered by a micro-computer processor device 12 exemplified a raspberry pi device that interacts with peripheral systemic components using Wi-Fi, LTE, Bluetooth, or some other internet connection.

The visual display 23 in FIG. 4 demonstrates a touchscreen monitor for enabling the display of information and further enables the collection of data. The data points displayed upon the touch screen visual display 23 can be configured and organized in any manner on the touch screen visual display 23. The screen displays important information to the service technician 100 in order to verify the correct vehicle 15 is being serviced. The preferred data points are referenced at reference numbers 31-46 upon the FIG. 4 depictions as discussed in more detail hereinafter.

Data point or metric 31 shows an exemplary Bayley™ logo, a source identifier of the system offered by the author of these specifications. The logo data point 31 has the ability to be white-labeled to match the dealership or service center. The repair order number data point or metric 32 is used to track the targeted vehicle 15 throughout the service process and may preferably be printed on a key tag associated with the vehicle 15. In other words, this metric represents the tracking number for the vehicle 15 in service. This number is entered by the service technician 100 in the previous step and a lookup is performed. The service technician 100 reviews the data returned from the repair order lookup and then verifies the correct vehicle 15 is being serviced, editing information where necessary.

The RFID/NFC sensor interface as at 25 reads a unique user id (UUID) that is associated with this repair order number data point 32 on the SBT system. The service technician identification number data point or metric 33 is used to track data on the service technician 100 and the services that are performed by the service technician 100. In other words, this metric represents the technician's ID that is currently working in the service bay station 10. This number is entered in by the service technician 100 in a previous step and tracks the service technician 100 as he or she works in different service bay stations 10 on different vehicles 15. This metric can be automatically entered using RFID, QR Code, or facial recognition. This data may also preferably include multipoint inspections and upsells that are offered directly to the customer.

The total time data point or metric 34 displays the total time since a vehicle repair order was written. This data point or metric 34 is used to track the total time a vehicle 15 has been in the service center or within the possession of the service department. There are some caveats, as might be the case for night time vehicle drops and valeted vehicle pickups, but generally this data point or metric 34 provides accurate accounting of total time. The lift time data point or metric 35 is a measure of time since the vehicle 15 has been in a service bay station 10. This data begins to be collected when an electronic sensor/signal device 11 sends a signal indicating a vehicle 15 has arrived in the service bay station 10.

This metric 35 may preferably derive from the use of one or more ultrasonic sensors that are mounted to the service bay station 10 structure and in communication with the micro-computer processor device 12. When a vehicle 15 is brought into the service bay station 10, it creates a disturbance in the directed ultrasonic wave pattern and at least one timer is started to record how long the vehicle 15 has been in the service bay station 10. As long as the sensors 11 continue to send signals, a vehicle 15 is considered to be actively being worked on. There are some caveats such as when a vehicle leaves the service bay station 10 for an alignment or a car wash. The SBT system can monitor these satellite bays as well and take that into consideration for the lift time data point 35.

The customer information data point or metric is referenced at 36. This data is interactive and by navigating to the data point 36 via the touch screen function or a mouse, a submenu allows text and/or imagery to be sent to the customer with a view toward initiating a communication thread. The vehicle information data point 37 ensures the service technician 100 can see the type and registration of the identified vehicle 15 to verify it is the correct vehicle 15. The metric 37 may further comprise a Vehicle Identification Number or VIN number. This represents the unique VIN for the vehicle 15 in for service, and is another mechanism or metric to ensure the vehicle 15 in the service bay station 10 is the correct vehicle 15.

The Let's Get Started data point or metric 38 depicts the amount of time that can be saved if the repair order items are done in the order listed. The metric 38 can be based on previous performance measures of the particular service technician 100 who is logged in and upon recommended hours from published standards. This is based on Artificial Intelligence (AI) and times allotted. The number of service items in the repair order is indicated at data point or metric 39, and the estimated time the entire repair order should take based on standard flat rate time is indicated at data point or metric 40.

A list of items that make up the repair order is indicated at data point or metric 41. The list data point/metric 41 lists the services to be performed and the amount of time each service should take based on a standard flat rate system. Each vehicle 15 may be in the service center for a single our multiple services; this list defines all of the services the customer initially wished to have performed on the vehicle 15. If the customer agrees to more services whilst the vehicle 15 is in the service bay station 10, this list will update with newly approved services.

The metric 41 list uses timers to maintain a running clock when each service is being performed. As a service technician 100 selects a service, a clock is started and continues to run while that particular service is actively being worked on. When a new service item is selected the current service item clock is stopped and the new service items clock is started. This provides the SBT system with the amount of time a specific technician 100 took to complete a specific job. There are many other data metrics that can be acquired from these measures of time expenditure, and one of them is the amount of time a combination of services took in the order that they were performed. This data enables an Artificial Intelligence support system of the SBT system to learn in which order the services should be performed to save the most time.

A multipoint acknowledgement and start screen data point is indicated at reference number 42. In this regard, it is noted that most service technicians 100 are required to perform a multipoint inspection. This button allows the service technician 100 to start the multipoint inspection using the SBT display 23 or provides a QR code that can be scanned by a tablet or mobile phone allowing the inspection to take place on an external device that reports back to the SBT system. This allows more flexibility for the service technician 100 and provides an easy way to add pictures and videos of the inspection results.

This aspect of the service protocol requires the service technician 100 to inspect the entire vehicle inside and out for possible issues. Based on this multipoint inspection, the service technician makes recommendations to the customer. This is can be done via a paper printout or electronic delivery and approval. The data point at 43 reminds the service technician 100 that until the multipoint inspection is complete, the service technician 100 cannot move on to next step.

The time it has taken or is taking to perform a specific item on the repair order list is denoted at data point or metric 44. Data point or metric 45 depicts whether or not the parts for a specific item are available at the time of service. In other words, this button represents the status of the parts needed for this service. The button may preferably change color depicting the status of parts. If parts are not available then the service will automatically be moved to the bottom of the service list as the service technician waits for the parts to arrive at the service bay station 10 particularly or the service center generally.

The data point/metric 46 provides a description of the specific service and provides an external or internal source showing a diagram of the service item being performed. These diagrams can include part numbers and directions for the service. The start multipoint data point or metric 47 generates a QR code that is scanned from a mobile device providing a mobile interface to perform the multipoint inspection. This interface allow pictures and videos to be added to the inspection report and communication with the advisor and or customer.

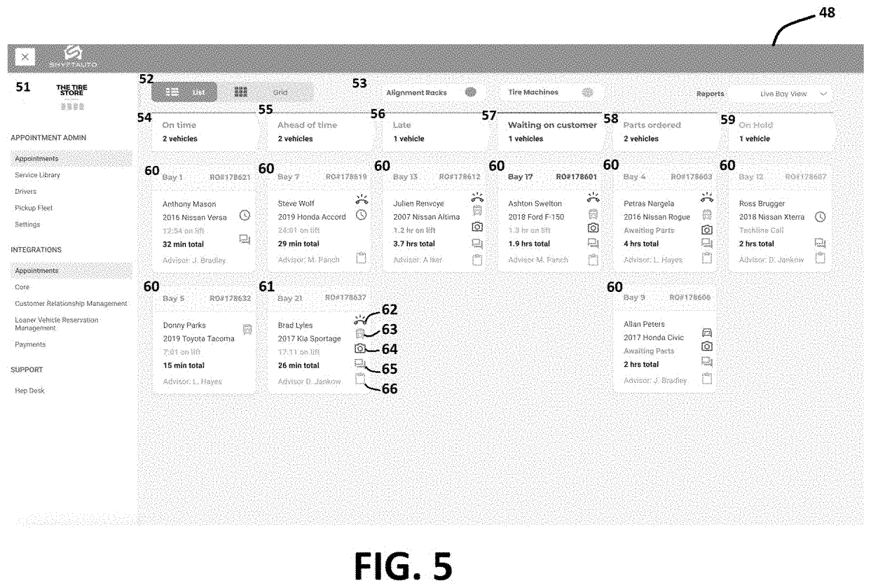

Referencing FIG. 5, the reader will there consider a view of the remotely viewable status dashboard 48 provided to advisors or other employees wishing to see the status of all, or a subset, or a single vehicle that has been checked in by creating a repair order. The status of each vehicle 15 is represented by a single card 60 on the KanBan board as a project management tool designed to help visualize work, limit work-in-progress, and maximize efficiency or flow. The status dashboard 48 shows data about each vehicle 15 and its progression in the repair order process. The left side of the screen presents a menu 51 of options within the SBT system. The appointments tab represents the status of vehicles 15 currently in for service at the service center.

A button feature at the top portion of the screen as at reference number 52 provides a way to change the perspective of the viewable data points. There are many ways to display data, this button 52 allows the user to change the way data is displayed. The indicators referenced at 53 highlight the use of remote Service Bay Timer installations exemplified by alignment rack installations and tire machine installations. The indicators at 53 indicate if a machine or installation is in use. Right clicking on the indicator 53 of choice displays status data about the usage of the specific machines.

There are preferably a number of configurable columns as at columns 54-59 that represent different status points of vehicles 15 in for service. Column 54, for example, represents the number of vehicles 15 that are on time for completion. The metrics representing vehicle progress are automatically moved between columns as changes in status occur. Column 55 represents the number of vehicles 15 that are ahead of schedule according to the estimated time given to the customer or the estimated time based on a standard flat rate. Column 56 represents the number of vehicles 15 that are behind schedule according to the estimated time given to the customer or the estimated time based on a standard flat rate. Column 57 represents the number of vehicles 15 that have finished the service process, but are waiting to be picked up by the customer. Column 58 represents the number of vehicles 15 that are in the service center but are waiting on the arrival of parts before completion. Column 59 represents the number of vehicles 15 that are on hold for some reason.

While the service bay station tiles or cards referenced at 60 can be displayed in many different views or perspectives, the current view depicts a plurality of service bay station cards 60 each of which represents a specific vehicle 15 in the service center for service. The vehicle Repair order number is visible at the top of each card. This is how each vehicle 15 is tracked within the service center and throughout the many different software vendors systems. These cards 60 typically originate within the dealer management system, and each card 60 is configurable to depict different data points. In the illustrated examples, each card 60 shown displays customer name; the year, make, and model of the vehicle; the time it has been in a service bay station 10, the time since the repair order for the vehicle 15 was originated; and advisor name.

Each card 60 on the board represents a single service bay station 10 or reserved station such as a car wash or alignment bay. The cards 60 are programmatically moved from column to column as work is reported to the system from the SBT timers and interactions. Each representation provides detailed information about the vehicles 15 in for service and can be manipulated to change the order of services in real time. Each card 60 displays pertinent information about each process including, but not limited to contact with customer, pictures or images sent, MPI completion, etc.

There are many possible icons that can be displayed on the tiles or cards 60 representing each vehicle 15. On the highlighted card 61 shown in FIG. 5, the icons from top to bottom represent: (1) icon 62 may be referenced to determine whether the customer been contacted by phone or in person since the repair order has been open; (2) icon 63 may be referenced to determine whether the customer has taken a shuttle after dropping off a vehicle 15 or whether the customer used a valet service or whether the customer remains on the premises; (3) icon 64 may be referenced to determine whether any pictures or videos have been taken of the vehicle 15 and if so, were they sent to the customer; (4) icon 65 may be referenced to determine whether there has been any text communications with the customer (clicking on the icon can bring up any specific text messages if the service is used for texting); and (5) icon 66 may be referenced to determine whether any internal notes about the repair order were input by the service technician 100 or other repair professionals.

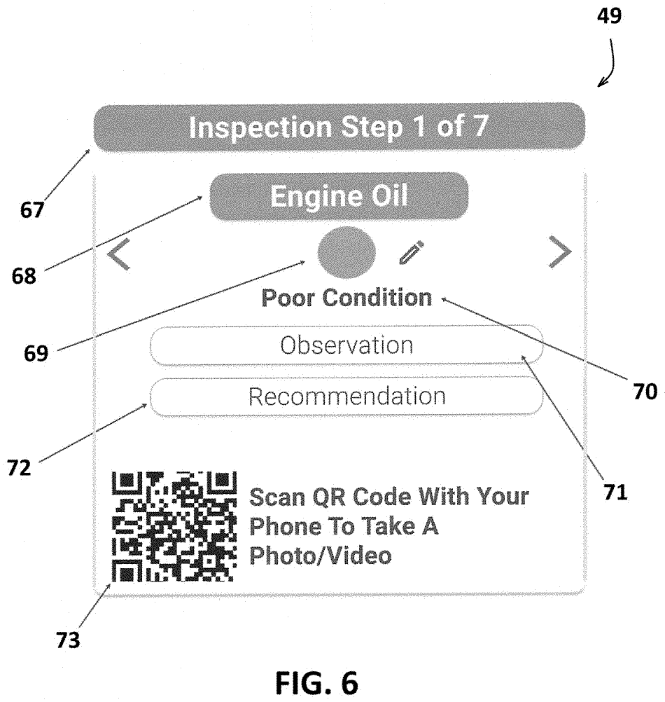

Referencing FIG. 6, the reader will there consider a screenshot 49 view of a single point in the Multi Point Inspection (MPI) process. A technician multipoint inspection step notification is depicted and referenced at 67. The number of points is defined by the specific customizable MPI. Each point in the inspection has a specific item to be inspected (e.g. a label 68 depicting what is being inspected) and range of values that decide the status of the inspection, which may be represented by color coded badges as at 69 with accompanying textual descriptions 70 representing inspection grade assigned to label item 68. The status can be poor, pass, warning, or fail, for example.

The view offers a way for the service technician 100 to add data representing observations as at button 71 for commenting on the specific inspection item as well as recommendations as at button 72 to offer remedies for any pertinent observations. There is preferably also a QR code feature as at 73. The QR code 73 is generated by a remote server (e.g. within the cloud computing network 20) that allow the service technician 100 to transfer the flow of the inspection to his or her phone or tablet to take pictures and video of the item in question and to make other observations during the inspection process which can then be communicated to the customer or stored in the remote system storage database 24.

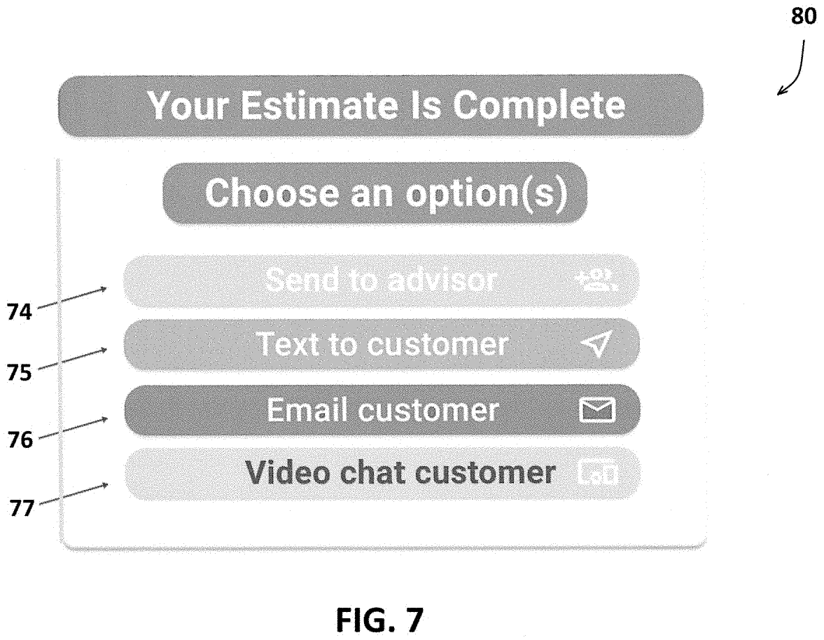

Referencing FIG. 7, the reader will there consider a screenshot 80 depicting multipoint inspection delivery options for the service technician 100, service advisor or other employee with permissions. Button 74 enables the service technician 100 to send the MPI to the advisor before the customer; button 75 enables the service technician 100 to communicate directly with the customer via SMS text; button 76 enables the service technician 100 to communicate directly with the customer via email; and button 77 enables the service technician 100 to communicate directly with the customer via video chat mechanism of the SBT system. In this last regard, the 77 button includes the ability to send a link to the customer for a video chat that can take place on the technician's or advisor's phone or tablet.

The primary objective of the SBT System according to the present invention is to gather data from software-enabled components or devices and use that data to provide logistics and a software-driven interface to provide real time information to the service technician 100. This data is used to improve a service technician's use of time by providing detailed steps and timestamps for each step. The data is also used to present information to management for providing a real time view of current work load and status of a sub set of service bay stations 10 or a complete view of all the service bay stations in a vehicle service center scenario.

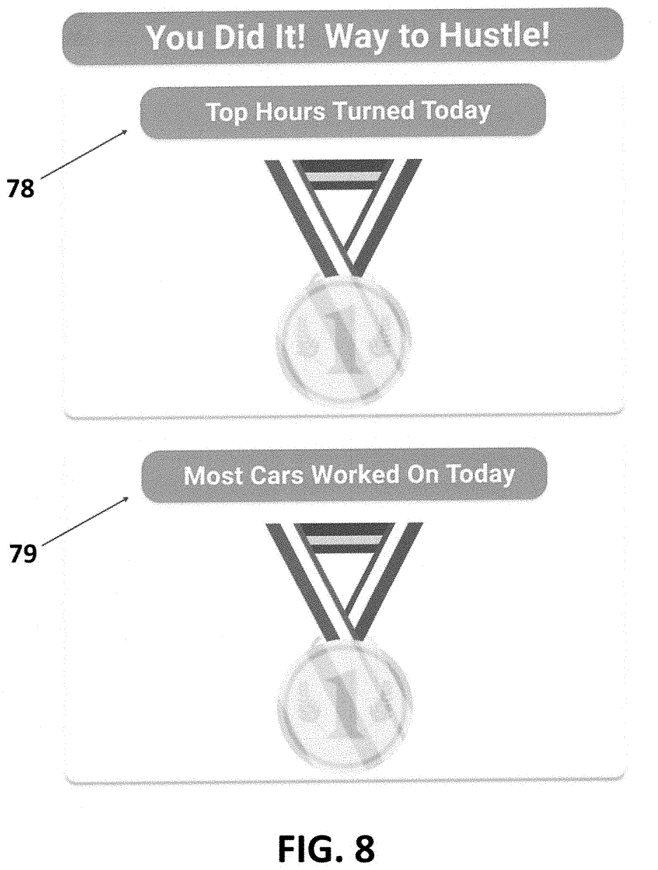

The data gathered from the SBT system may also be used to grade service technicians 100 on the work they have completed and register actual time of completion for each service for each service technician 100. This provides a system to track and possibly reward service technicians 100 based on performance. FIG. 8 depicts, for example, an exemplary award screenshot 81 for a top-performing service technician, including an exemplary Top Hours Turned Today award as at 78, and a Most Cars Worked on Today award as at 79.

The SBT system according to the present invention thereby helps reinforce superior services by service technicians 100 in an effort to help them become more efficient and accurate. Algorithms implemented by the non-transitory, computer-implementable medium or software application according to the present invention are thus able to provide guidance to service technicians 100 as they navigate through each step of a service repair order. The SBT system thus reinforces efficient service technicians 100 with a built-in reward system. The SBT system according to the present invention provides a game like experience for service technicians 100 who in turn can use the system to become more efficient.

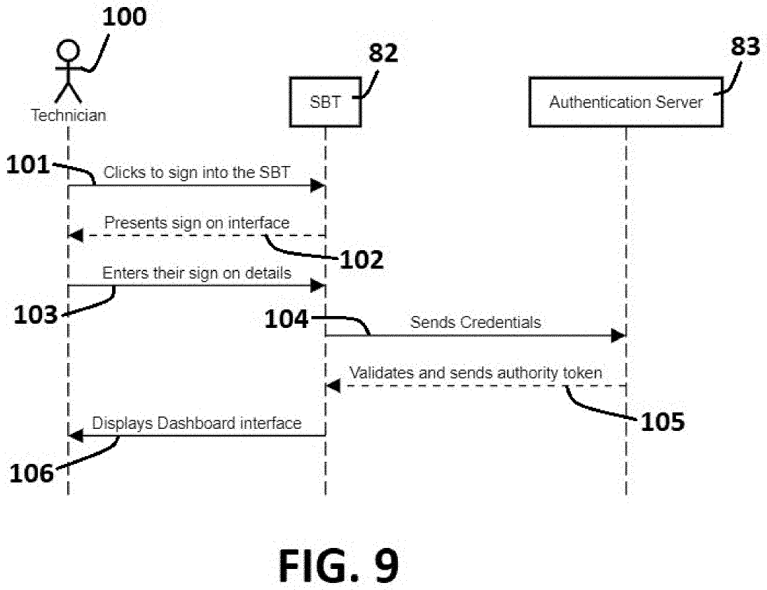

Referencing FIG. 9, the reader will there consider a flowchart diagram of the process a technician 100 goes through to login to the SBT system as at tier 82, which SBT level or tier 82 is in communication with a remote authentication server as at 83 within the cloud computing network 20. The service technician 100 first clicks as at arrow 101 a prompt upon the visual display 23 of the user interface 14 to sign into the SBT system. The SBT system responds with a sign-on prompt or interface as at arrow 102. The service technician 100 then enters his or her sign on details as at arrow 103, and the SBT system sends the credentials as at arrow 104 to the authentication server 83 for authentication. The authentication server 83, once the credentials are authenticated, will validate and return an authority token as at arrow 105, which authority token operates to display the dashboard interface upon the visual display 23 of the user interface 14 as referenced at arrow and as 106 otherwise generally depicted in FIG. 4.

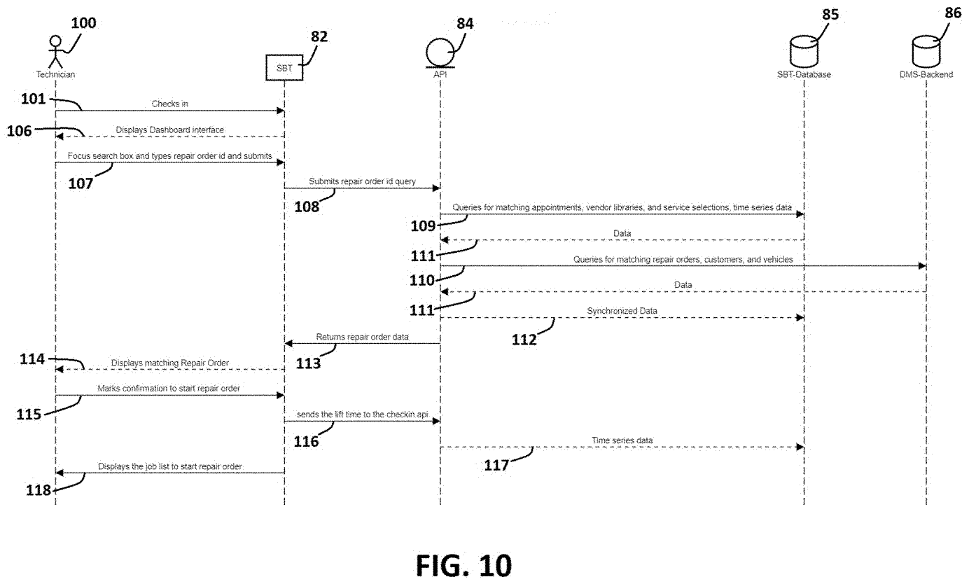

Referencing FIG. 10, the reader will there consider a flowchart type diagram comprising a five levels or tiers of systemic architecture, including a client-side level or tier as at service technician 100, an SBT level or tier as at 82, an application programming interface level or tier as at 84, an SBT database level or tier as at 85, and a DMS backend level or tier as at 86. The service technician 100 first checks into the SBT tier 82 as per the protocol described in connection with FIG. 9 whereafter the service technician 100 inputs the repair order identification number as at arrow 107, which query is then sent as at query 108 to the Application Programming Interface (API) tier 84. From the API tier 84, the system queries as at 109 the SBT database tier 85 for matching appointments, vendor libraries, service selections and time series data and queries the DMS-backend tier 85 for matching repair orders, customers, and vehicles as at arrow 110.

Requested data is returned as at arrow 111, and a channel is developed for synchronizing data with the SBT database tier 85 and the DMS-backend tier 86 as at arrow 112. The API tier 84 returns as at 113 repair order data to the SBT tier 82, which then displays as at 114 the matching repair order data upon the visual display 23 of the user interface 14 at the client-side tier or to the service technician 100. The service technician 100 confirms the start of the repair order as at arrow 115 and the SBT tier 82 sends service time data to the API tier 84 as at arrow 116 whereafter time series data is uploaded to the SBT-database tier 85 as at arrow 117 and the SBT tier 82 displays as at 118 the job list upon the visual display 23 of the user interface 14 to prompt the service technician 100 to begin the repair order.

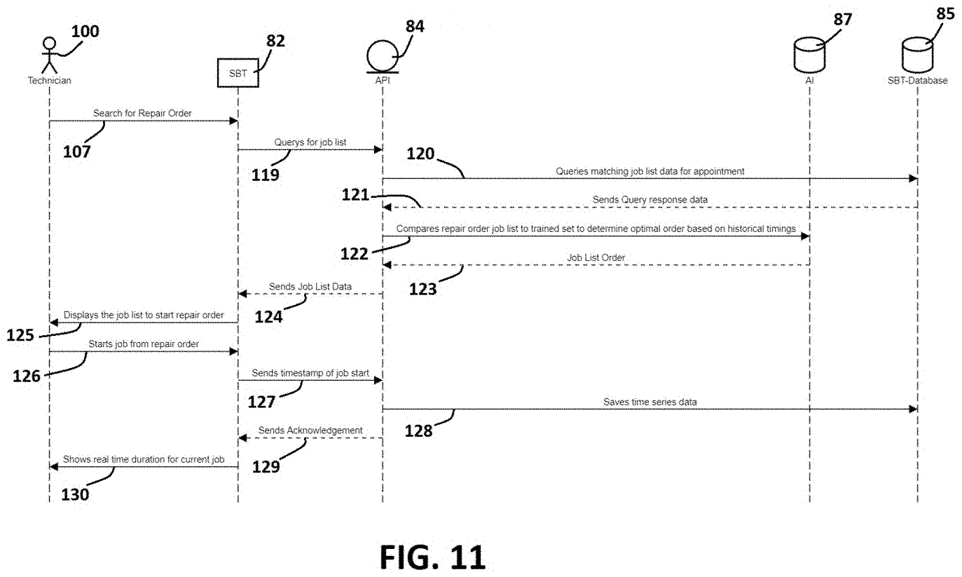

Referencing FIG. 11, the reader will there consider a flowchart depicting a 5 level or tier schema for supporting a repair order triage feature of the SBT system according to the present invention, including a client-side level or tier as at service technician 100, an SBT level or tier as at 82, an Application Programming Interface (API) level or tier as at 84, an Artificial Intelligence (AI) level or tier as at 87; and an SBT-database level or tier as at 85. The service technician 100 again searches the SBT tier 82 for a repair order as at 107, and the SBT tier 82 queries the API tier 84 for a job listing as at arrow 119. The API tier 84 queries as at arrow 120 the SBT-database tier 85 for matching job list data for the appointment, which returns response data as at arrow 121 to the API tier 84.

The API tier 84 then compares as at arrow 122 repair order job list to a trained set to determine optimal order of job steps based on historical timings as governed by an Artificial Intelligence or AI tier 87, which AI tier 87 returns as at arrow 123 an optimal job order listing to the API tier 84. The API tier 84 send job list data as at arrow 124 to the SBT tier 82 which displays as at arrow 125 the job list data upon the visual display 23 of the user interface 14 to guide the service technician 100 as he or she moves through the job listing.

When the service technician 100 begins the service he or she starts the repair order as at arrow 126, and the SBT tier 82 sends a job start timestamp as at arrow 127 to the API tier 84 saving time series data at the SBT-database tier 85 as at arrow 128. The API tier 84 sends an acknowledgement as at arrow 129 to the SBT tier 82 and the visual display 23 of the user interface 14 shows or displays as at arrow 130 time elapsed in real time for the current job being performed by the service technician 100.

Using the data points gained from the SBT system, the non-transitory, computer-implementable medium/software application driving the SBT system can accurately detect bottlenecks in systemic flow and guarantee the service technician 100 is made aware of each step and the order in which service steps should be accomplished to improve overall efficiency. The invention provides proven service procedures for a more consistent execution of vehicle services. The invention provides a way for advisors to interact with technicians via a software-based solution thereby preventing the need to visit a shop floor to acquire updates on vehicle status.

The internal non-transitory, computer-implementable medium or software application made central to the practice of the present invention is implementable by the computer-processor device 12 and peripheral hardware components for collecting, storing, and processing data received from (a) the user or service technician, (b) the signaling devices, and (c) the timer devices. The internal non-transitory, computer-implementable medium or software application outputs data as processed and compiled to the user or service technician upon the visual display 23 of the user interface 14 for directing and governing the user/service technician while servicing the vehicle 15 as received in the service bay station 10.

The SBT system according to the present invention collects and compares data points and shares the collected/compared data with an external system to allow those data points to be stored and compared over time by way of the cloud computing network 20 and offsite storage database as at 24, creating maps that can represent a plethora of calculations and data output, including but not limited to: individual technicians' use of time; ranking of technicians; missing or unaccounted for steps; real time customer engagement and updates of status for improving customer experience; real time diagrams of the intended vehicle repair; parts availability for the repairs intended; and ability to use the system to communicate directly with different systems within a service center including but not limited to the parts department, the new and used car departments, service advisors and customers.

The object of the invention is to provide data points that can be used to provide better practices when servicing vehicles. The Service Bay Timer system collects data from a service technician 100 as a vehicle 15 is being serviced while at the same time providing useful feedback for the service technician 100. Feedback provided to the service technicians 100 includes steps and most efficient order of steps for a particular service. Providing a running time of the service being performed and an indicator of where in the process a service technician 100 should be helps identify bottlenecks in the service process and allow those bottlenecks to be diagnosed. Diagnosis can provide a solution in the way of specific steps and order to complete the service.

The invention uses a number of closed systems to accomplish its goals. The first system in the process is a signaling device that will notify software when a vehicle 15 has entered a service bay station. This system initially will consist of an ultrasonic sensor that uses sound waves to determine the distance of an object. As a vehicle 15 enters a service bay station 10, the ultrasonic waves will determine if there is a vehicle 15 within a specific configurable distance. The pretense of a vehicle 15 sends a notice to the system. The computer-processor device 12 may be preferably exemplified initially be a raspberry pi device, but other similar computer-processor devices 12 are contemplated. There are also other ways and means to detect a vehicle 15 entering a service bay station 10 that could be alternatively utilized in support of the system.

The second system in the process is the computer-processor device 12. The computer-processor device is responsible for evaluating the signal coming from the service bay station 10. When the signal notifies the processor 12 that a vehicle 15 has entered the service bay station 10, it will start at least one, but preferably a series of timers. The initial timer is used to determine the duration that the vehicle 15 is “in service” as well as the duration between vehicles 15 being in the service bay station, “out of service”. Using these durations, the system can compare the times to industry standard times and make recommendations.

Other secondary timers may be started by the processor 12 to time each step of a service step or process and present alerts when a step is missed or is taking too long. If certain steps are consistently taking longer or shorter than the industry standard, alerts are preferably sent to the service technician 100 and/or other interested parties such as owners/managers. Once a problem is detected by the Service Bay Timer system, actions to resolve the issues can be taken. These timers can be used to compare service technicians 100 to reward efficiency and/or identify problem areas for individual service technicians 100.

The second external system that the Service Bay Timer system can communicate with is an external program that will store the data being collected and use that stored data to make further calculations and identify trends among services and service technicians 100. The SBT system according to the present invention may thus providing a ranking of service technicians for specific services, calculate cost over time for services, determine how often a service is in use, and use the data points to improve performance. This external software system may preferably communicate with the Service Bay Timer system via a wireless network, Bluetooth, USB port or some other medium.

While the above descriptions contain much specificity, this specificity should not be construed as limitations on the scope of the invention, but rather as an exemplification of the invention. In certain embodiments, the basic invention may be said to essentially teach or disclose a service bay timer system for gathering data from a service bay station, processing data gathered from the service bay station, and providing feedback to a service bay technician at the service bay station for improving use of service time by the service technician at the service bay station.

The service bay timer system according to the present invention may be said to essentially comprise, in combination, a service bay station, at least one signaling device, a computer-processor device, at least one timer mechanism, a user interface, and an internal non-transitory, computer-implementable medium or software application implementable by the computer-processor device. The service bay station is preferably configured to receive a vehicle for service and comprises at least one device-support structure as exemplified by an upright, column or post as at 16.

The at least one signaling device is preferably supported by the at least one device-support structure in a position for detecting vehicular presence at or within the service bay station. The computer-processor device is in communication with the at least one signaling device for receiving signals therefrom and initiating the at least one timer mechanism also in communication with the computer-processor device. The user interface, preferably also supported by the service bay station, is in communication with the computer-processor device for (a) enabling a user to input data for processing by the computer-processor device and other peripheral systems and (b) for outputting information/data to the user or service technician.

The internal non-transitory, computer-implementable medium or software application that is implementable by the computer-processor device and other peripheral computing devices enables the system to collect, store, and process data received from (a) the user or service technician, (b) the at least one signaling device, and (c) the least one timer mechanism. The collected, stored, and processed data can then be used for data output to the user upon the user interface 14 for directing and governing the user while servicing the vehicle 15 as received in the service bay station 10.

The service bay timer system may preferably comprise at least two signaling devices. A first of the at least two signaling devices is preferably positioned at the service bay station for detecting vehicular presence from a first direction. A second of the at least two signaling devices is preferably positioned at the service bay station for detecting vehicular presence from a second direction such that the second direction is obliquely angled relative to the first direction for enhancing detection of vehicular presence at or within the service bay station.

The service bay timer system according to the present invention may further preferably comprise a series of timer mechanisms. In this regard, the series of timer mechanisms may preferably comprise a first timer for determining a duration of vehicle presence and in service within the service bay station, while at least one second timer is operable to determine duration of each step of a preferred service process. Both time measures may be preferable displayed upon the user interface or separately upon the service bay station itself upon a separate time display.

The internal non-transitory, computer-implementable medium, in cooperation with the at least one second timer, is configured to provide an excess time alert upon the user interface when the second timer measures a length of time in excess of a threshold preferred time for a given service step. The internal non-transitory, computer-implementable medium is further preferably configured to provide a missed step alert when the user fails to input a step completion for a select step from a preferred service step protocol.

The internal non-transitory, computer-implementable medium may be further preferably configured to determine user consistency in service time overages or service time deficits, and to compare the user consistency in service time overages or service time deficits to industry standards for triggering alerts to at least one interested party for prompting a select action. The internal non-transitory, computer-implementable medium may be further configured to determine user consistency in service time overages or service time deficits, and to compare the user consistency in service time overages or service time deficits to other on-site user data for triggering alerts to at least one interested party for prompting a select action (e.g. rewards for efficiency or corrective action for problem areas).

The service bay timer system according to the present invention may further preferably comprise or communicate freely with an external non-transitory, computer-implementable medium in communication with the internal non-transitory, computer-implementable medium. The external non-transitory, computer-implementable medium may be preferably configured to collect, store, and analyze data over time for identifying time-based trends among service orders and user technicians and providing informational output.

The informational output may be exemplified by the provision of a ranking for technicians for specific services; calculating cost over time for services; determining how often a service is in use, and use the data points to improve performance. This external software system or external non-transitory, computer-implementable medium may preferably connect to the Service Bay Timer via a wireless network, Bluetooth, USB port or some other medium.

The service bay timer system according to the present invention may be said to further preferably comprise certain means for token-identifying a repair protocol for select vehicles entering the service bay station. Said means may be preferably exemplified by an RFID/NFC sensor as at 25. Select vehicle(s) entering the service bay station may each be preferably outfitted with an information-bearing token (e.g. RFID/NFC stickers, chips, tokens). The means for token-identifying a repair protocol may then read the information-bearing token(s) for triggering a select repair protocol for each select vehicle 15 entering the service bay station 10, which repair protocol is output upon the visual display 23 of the user interface 14.

One of the primary benefits of the SBT system according to the present invention is the provision of the dashboard referenced at number 48 made the subject of FIG. 5. The dashboard 48 provides a real time view of the status of the service bay stations within a group using the SBT system and method. The dashboard 48 allows or enables a service manager who is the middleman between the service technician and the customer to see the status without having to walk back into the service bay station area and speak to the service technician, thereby saving time for the advisor and the technician who would have to stop working to describe the status. In view of the foregoing, the present invention may be said to further comprise a dashboard viewable upon a visual display remote from the service bay station, which dashboard provides a real time status view of a series of service bay stations within a group thereby enabling a second or remote user to monitor service bay station status for any of the series of service bay stations within the group.

Viewed methodologically, the present invention may be said to essentially provide a service bay timing method for gathering data from a service bay station, processing data gathered from the service bay station, and providing feedback to a service bay technician at the service bay station for improving use of service time by the service technician. The service bay timing method may be said to preferably comprise a series of essential steps including initially outfitting a service bay station configured to receive a vehicle for service and comprising at least one device-support structure.

The service bay station is preferably outfitted with at least one signaling device and a user interface upon the at least one device-support structure. The vehicle is then sensed as received at the service bay station via the at least one signaling device, which signaling device or devices signal a computer-processor device. At least one timer device or mechanism is started via the computer-processor device for tracking the duration of time the vehicle is received at the service bay station. The vehicle and a repair job associated with the vehicle is identified via a user interface in communication with the computer-processor device.

Being prompted by output displayed upon the user interface, the user may then input data into the user interface as service progresses. The internal non-transitory, computer-implementable medium implementable by the computer-processor device enables the system to collect, store, and process data received from (a) the user, (b) the at least one signaling device, and (c) the least one timer mechanism for outputting first form data to the user upon the user interface for initially directing and governing the user while servicing the vehicle as received in the service bay station.

The service bay timing method may further preferably comprises the steps of: comparing input data as input by the user and the various peripheral signaling and timing mechanisms to industry standard data stored within a database. The input data and industry standard data may then be compared via the internal non-transitory, computer-implementable medium implementable by the computer-processor device for outputting second form data upon the user interface for redirecting and governing the user while servicing the vehicle as received in the service bay station. The notion here being addressed or defined is that the system continually monitors systemic input data and can adjust the output, if necessary, so as to redirect the service technician.

The service bay timing method may further preferably comprises the steps of: identifying the user or service technician who has a user profile stored within the system database. Input data, industry standard data, and user profile data are then processed via the non-transitory, computer-implementable medium implementable by the computer-processor device for outputting third form data upon the user interface for redirecting and governing the user while servicing the vehicle as received in the service bay station. The notion here being addressed or defined is that the system continually monitors systemic input data relative to specific technicians and their past performance so that the system can adjust the output for redirecting the service technician, if necessary.

The service bay timing method may further preferably comprises the step of: outfitting the service bay station with at least two signaling devices such that a first of the at least two signaling devices is positioned at the service bay station for detecting vehicular presence from a first direction; and a second of the at least two signaling devices is positioned at the service bay station for detecting vehicular presence from a second direction. The second direction is preferably obliquely angled relative to the first direction for enhancing the step of sensing the vehicle as received at the service bay station.

The service bay timing method may further preferably comprise the steps of: starting a first timer for determining a duration of vehicle presence and in service within the service bay station; and starting at least one second timer for determining duration of each step of a preferred service process as output on the user interface. The time duration for each step of the preferred service process as measured by the at least one second timer may then be compared to a threshold preferred time duration associated with each step.

An excess time alert may then be provided upon the user interface when the at least one second timer measures a length of time in excess of the threshold preferred time duration for a given service step. Similarly, input service step data may be compared to preferred service step data via the internal non-transitory, computer-implementable medium; and a missed step alert may be provided when the user fails to input step completion for a select step from a preferred service step protocol.

The service bay timing method may further preferably comprise the steps of: comparing user consistency data to industry standard data via the internal non-transitory, computer-implementable medium; and alerting at least one interested party when user consistency data rises above or falls below a threshold value derived from the industry standard data. Similarly, user consistency data may be compared to service center data via the internal non-transitory, computer-implementable medium; and at least one interested party (i.e. an owner or manager) may be alerted when user consistency data rises above or falls below a threshold value derived from the service center data.

In other words, the internal non-transitory, computer-implementable medium is preferably configured to determine user consistency in service time overages or service time deficits, and to compare the user consistency in service time overages or service time deficits to other on-site user data for triggering alerts to at least one interested party for prompting a select action (e.g. rewards for efficiency or corrective action for problem areas).

The service bay timing method may be further said to preferably comprise the steps of: accumulating data via an external non-transitory, computer-implementable medium in communication with the internal non-transitory, computer-implementable medium. The external non-transitory, computer-implementable medium is configured to collect, store, and analyze data over time for identifying time-based trends among service orders and user technicians and providing informational output which may be sent to the service technician, owners, or managers for enhancing the overall efficiency of the service center.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps arc disclosed. Each of these has individual benefit and each can also be used in conjunction with one or more, or in some cases all of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

Accordingly, although the invention has been described by reference to certain preferred embodiments, and certain associated methodologies, it is not intended that the novel systemic arrangements and associated methods be limited thereby, but that modifications thereof are intended to be included as falling within the broad scope and spirit of the foregoing disclosures and the appended drawings. Insofar as the description above and the accompanying drawings disclose any additional subject matter that is not within the scope of the claims below, the embodiments are not dedicated to the public and the right to file one or more applications to claim such additional embodiments is reserved.

What is claimed is:

1. A service bay timer system, the service bay timer system for improving use of service time by a user at the service bay station, the service bay timer system comprising, in combination:
a service bay station, the service bay station being configured to receive a vehicle for service and comprising at least one device-support structure;
at least one signaling device, the at least one signaling device being supported by the at least one device-support structure;
a computer-processor device, the computer-processor device being in communication with the at least one signaling device for receiving signals from the at least one signaling device;
at least one timer mechanism, the at least one timer mechanism being in communication with the computer-processor device, signals from the at least one signaling device for initiating the at least one timer mechanism via the computer-processor device;
a user interface, the user interface being in communication with the computer-processor device, the user interface for (a) enabling a user to input data for processing by the computer-processor device and (b) for outputting data to the user;
an internal non-transitory, computer-implementable medium being implementable by the computer-processor device for enabling said system to collect, store, and process data received from the user, the at least one signaling device, and the least one timer mechanism, and outputting data to the user upon the user interface for directing and governing the user while servicing the vehicle as received in the service bay station.

2. The service bay timer system of claim 1 comprising at least two signaling devices, a first of the at least two signaling devices being positioned at the service bay station for detecting vehicular presence from a first direction, a second of the at least two signaling devices being positioned at the service bay station for detecting vehicular presence from a second direction, the second direction being obliquely angled relative to the first direction for enhancing vehicular presence detection.

3. The service bay timer system of claim 1 comprising a series of timer mechanisms, the series of timer mechanisms comprising a first timer for determining a duration of vehicle presence and in service within the service bay station, at least one second timer for determining duration of each step of a preferred service process.

4. The service bay timer system of claim 3 wherein the internal non-transitory, computer-implementable medium, in cooperation with the at least one second timer, is configured to provide an excess time alert upon the user interface when the second timer measures a length of time in excess of a threshold preferred time for a given service step.

5. The service bay timer system of claim 1 wherein the internal non-transitory, computer-implementable medium is configured to provide a missed step alert when the user fails to input step completion for a select step from a preferred service step protocol.

6. The service bay timer system of claim 1 wherein the internal non-transitory, computer-implementable medium is configured to determine user consistency in service time overages or service time deficits, and to compare the user consistency in service time overages or service time deficits to industry standards for triggering alerts to at least one interested party for prompting a select action.

7. The service bay timer system of claim 1 wherein the internal non-transitory, computer-implementable medium is configured to determine user consistency in service time overages or service time deficits, and to compare the user consistency in service time overages or service time deficits to other on-site user data for triggering alerts to at least one interested party for prompting a select action.

8. The service bay timer system of claim 1 comprising an external non-transitory, computer-implementable medium in communication with the internal non-transitory, computer-implementable medium, the external non-transitory, computer-implementable medium being configured to collect, store, and analyze data over time for identifying time-based trends among service orders and user technicians and providing informational output.

9. The service bay timer system of claim 1 comprising means for token-identifying a repair protocol for select vehicles entering the service bay station, the select vehicles entering the service bay station each being outfitted with an information-bearing token, said means for token-identifying a repair protocol reading the information-bearing tokens for outputting a select repair protocol for each select vehicle entering the service bay station.

10. The service bay timer system of claim 1 comprising a dashboard viewable upon a visual display remote from the service bay station, the dashboard providing a real time status view of a series of service bay stations within a group, the dashboard enabling a remote user to monitor service bay station status for any of the series of service bay stations within the group.

11. A service bay timing method, the service bay timing method for improving use of service time by a user at a service bay station, the service bay timing method comprising the steps of:
outfitting the service bay station, the service bay station being configured to receive a vehicle for service and comprising at least one device-support structure, the service bay station being outfitted with at least one signaling device upon the at least one device-support structure;
sensing a vehicle as received at the service bay station via the at least one signaling device, the at least one signaling device signaling a computer-processor device;
starting at least one timer mechanism via the computer-processor device as prompted by the at least one signaling device for tracking time the vehicle is received at the service bay station;
identifying the vehicle and a repair job associated with the vehicle as identified via a user interface in communication with the computer-processor device;
inputting data into the user interface by the user as service progresses;
collecting, storing, and processing data received from the user, the at least one signaling device, and the least one timer mechanism by way of an internal non-transitory, computer-implementable medium implementable by the computer-processor device; and
outputting first form data to the user upon the user interface for directing and governing the user while servicing the vehicle as received in the service bay station.

12. The service bay timing method of claim 11 comprising the steps of:
comparing input data to industry standard data stored within a system database, and
processing input data and industry standard data via the internal non-transitory, computer-implementable medium for outputting second form data upon the user interface for redirecting and governing the user while servicing the vehicle as received in the service bay station.

13. The service bay timing method of claim 12 comprising the steps of
identifying the user, the user having a user profile, the user profile being stored within the system database; and
processing input data, industry standard data, and user profile data via the non-transitory, computer-implementable medium implementable for outputting third form data upon the user interface for further redirecting and governing the user while servicing the vehicle as received in the service bay station.

14. The service bay timing method of claim 11 comprising the step of:
outfitting the service bay station with at least two signaling devices;
a first of the at least two signaling devices being positioned at the service bay station for detecting vehicular presence from a first direction; and
a second of the at least two signaling devices being positioned at the service bay station for detecting vehicular presence from a second direction, the second direction being obliquely angled relative to the first direction for enhancing the step of sensing the vehicle as received at the service bay station.

15. The service bay timing method of claim 11 comprising the steps of:
starting a first timer for determining a duration of vehicle presence and in service within the service bay station; and
starting at least one second timer for determining duration of each step of a preferred service process as output on the user interface.

16. The service bay timing method of claim 15 comprising the steps of:
comparing time duration for each step of the preferred service process as measured by the at least one second timer to a threshold preferred time duration associated with each step; and
providing an excess time alert upon the user interface when the at least one second timer measures a length of time in excess of the threshold preferred time duration for a given service step.

17. The service bay timing method of claim 11 comprising the steps of:
comparing input service step data to preferred service step data via the internal non-transitory, computer-implementable medium; and
providing a missed step alert when the user fails to input step completion for a select step from a preferred service step protocol.

18. The service bay timing method of claim 11 comprising the steps of:
accumulating data via an external non-transitory, computer-implementable medium in communication with the internal non-transitory, computer-implementable medium, the external non-transitory, computer-implementable medium being configured to collect, store, and analyze data over time for identifying time-based trends among service orders and users and providing informational output.

19. The service bay timing method of claim 11 comprising the steps of:
outfitting the vehicle with an information-bearing token; and
identifying a repair protocol for the vehicle as outfitted with the information-bearing token as it enters the service bay station via means for reading the information-bearing token.

20. The service bay timing method of claim 11 comprising the steps of:
displaying a dashboard upon a visual display remote from the service bay station, the dashboard providing a real time status view of a series of service bay stations within a group; and
remotely monitoring service bay station status for the series of service bay stations within the group.
